(19) United States
(12) Patent Application Publication
(10) Pub. No.: US 2023/0226721 A1
(43) Pub. Date: Jul. 20, 2023

(54) METHODS FOR MANUFACTURING OPTICAL PRISMS

(71) Applicant: ams Sensors Singapore Pte. Ltd., Singapore (SG)

(72) Inventors: QiChuan Yu, Singapore (SG); Sai Mun Chan, Eindhoven (NL); Ilias Bosdas, Eindhoven (NL); Kam Wah Leong, Singapore (SG); Quoc Bao Pham, Eindhoven (NL); Mark Dranreb Ulpindo, Eindhoven (NL)

(21) Appl. No.: 17/998,192

(22) PCT Filed: May 11, 2021
(86) PCT No.: PCT/SG2021/050257

§ 371 Date: Nov. 8, 2022

(30) Foreign Application Priority Data
May 12, 2020 (GB) 2006995.1

(51) Int. Cl. B28D 1/04; G02B 7/18; B28D 7/04

(52) U.S. Cl. CPC B28D 1/04; G02B 7/1805; B28D 7/04; G02B 1/11

(57) ABSTRACT

A method for producing a plurality of optical prisms comprises: providing at least one manufacturing intermediate; and dividing the at least one manufacturing intermediate into a plurality of individual triangular prisms. The manufacturing intermediate comprises a main body in the form of a triangular prism having three rectangular surfaces and two triangular surfaces. The main body is formed from a light-transmitting material. A layer of opaque material is provided on two of the three rectangular surfaces of the main body, the layer of opaque material having a plurality of axially spaced apertures on each of the two of the three rectangular surfaces, each one of the apertures on one of the two surfaces being disposed at substantially the same axial position as one of the apertures on the other one of the two surfaces. The at least one manufacturing intermediate is divided into a plurality of individual triangular prisms such that each individual triangular prism has one of the apertures on each of two sides thereof.

### TECHNICAL FIELD OF THE DISCLOSURE

This disclosure relates to a method for manufacturing a plurality of optical elements, in particular a plurality of prisms. The prisms may, for example, have optical power and may be provided with a lens at one or more surface.

### BACKGROUND OF THE DISCLOSURE

The present disclosure relates to a method for manufacturing a plurality of prisms. The prisms may, for example, have optical power and may be provided with a lens at one or more surface. In use, light may enter such a prism in a first direction through a first surface and may be directed to exit the prism in a second direction through a second surface. The first and second directions may be mutually orthogonal. Optionally, the prism may have optical power and may, for example, be operable to focus the light which enters the first surface.

Such prisms may find application in a plurality of different applications. For example, this type of prism may form part of a compact adjustable zoom lens arrangement (for example a telephoto lens). Such an arrangement may find application in the handset of a cellular telephone (also referred to as a mobile telephone).

One existing method for manufacturing such a prism with optical power involves the manufacture of a glass prism and a separate glass lens. The lens is then adhered to one surface of the prism (for example using an epoxy adhesive). Once the prism has been formed, surfaces of the prism except for the first and second surfaces (which, in use, form an inlet and outlet of the prism) may be coated with an opaque material.

It is therefore an aim of the present disclosure to provide a method for manufacturing glass prisms that address one or more of problems associated with prior art methods, whether identified above or otherwise. In particular, it may be an aim of the present disclosure to provide a method for manufacturing glass prisms that increases throughput of the production and/or reduces cost of the production.

### SUMMARY

In general, this disclosure proposes to overcome the problems in existing by forming one or more manufacturing intermediates and then subsequently dividing each manufacturing intermediate into a plurality of prisms. The manufacturing intermediate is of the form of an elongate prism which is provided with an opaque coating on a first and second surface, the opaque coating having a plurality of apertures. Subsequently, each of the one of more elongate prisms is divided into a plurality of separate individual of individual triangular prisms. This arrangement is advantage since it allows a plurality of prisms to be manufactured accurately in volume, as discussed further below.

According to a first aspect of the present disclosure, there is provided a method for producing a plurality of optical prisms, the method comprising: providing at least one manufacturing intermediate, the manufacturing intermediate comprising: a main body in the form of a triangular prism having three rectangular surfaces and two triangular surfaces, the main body being formed from a light-transmitting material; and a layer of opaque material provided on two of the three rectangular surfaces of the main body, the layer of opaque material comprising a plurality of axially spaced apertures on each of the two of the three rectangular surfaces, each one of the apertures on one of the two surfaces being disposed at substantially the same axial position as one of the apertures on the other one of the two surfaces; and dividing the at least one manufacturing intermediate into a plurality of individual triangular prisms such that each individual triangular prism has one of the apertures on each of two sides thereof.

Advantageously, the method according to the first aspect allows for the production of a plurality of prisms at high volume and throughput whilst maintaining high quality and within high manufacturing tolerance, as now discussed.

Prior art methods for manufacturing optical prisms involve the manufacture of each individual prism separately. For example, to ensure sufficient optical quality each individual prism may be formed by injection molding. However, once a main light-transmitting body of the prism has been formed, each such individual prism is typically subject to further processing steps. For example, a lens may be adhered to one surface of the prism to provide the optical component with optical power. In addition, it may be desirable to coat at least some surfaces (with the exception of an inlet portion on one surface and an outlet portion on another surface) with an opaque material, for example to prevent any light from entering or leaving the prism from locations other than the inlet portion and an outlet portion. Disadvantageously, this method is time consuming and expensive as each individual prism is subject to one or more such subsequent processing steps.

Compared to such known methods, the present method for producing a plurality of optical prisms disclosed here has the following advantages. First, forming at least one manufacturing intermediate having a layer of opaque material on two sides and then subsequently dividing this into separate individual prisms is significantly faster and more cost effective than molding a plurality of individual prisms and then providing an opaque layer with an aperture on each of two sides. The main body of the manufacturing intermediate can be formed in a single operation (for example injection molding) and the layer of opaque material can be easily formed using known techniques, for example using physical vapor deposition (PVD).

Second, the at least one manufacturing intermediate having a layer of opaque material on two sides allows for controlled positioning, pitch and height of an array of portions which will eventually each corresponding to an individual triangular prisms. A single manufacturing intermediate allows for very easy formation of a one-dimensional array of such portions; a plurality of manufacturing intermediates allows for very easy formation of a two-dimensional array of such portions. This is particularly advantageous since it allows a temporal array layout for subsequent processing steps (for example the provision of a lens to each portion and/or the division of these portions via a dicing process) to use wafer level optics technology. This further increases throughput of the manufacture whilst still providing sufficient precision to meets tight dimensional tolerance control.

Third, by providing the layer of opaque material on two sides of the at least one manufacturing intermediate before any other processing steps, this layer can advantageously aid the alignment of the manufacturing intermediates and/or the individual triangular prisms to allow for high throughput by batch processing using wafer level optics techniques. For example each aperture may be used as an alignment feature (or fiducial) to allow for fast and accurate alignment of the portion it is provided on with some other component (for example using wafer level optics or lithographic techniques).

Therefore the method according to the first aspect, through the use of the manufacturing intermediates, allows high volume manufacturing of prisms (which may be provided with a lens).

It will be appreciated that the step of providing at least one manufacturing intermediate may comprise sourcing the manufacturing intermediate pre-formed (for example via a third party supplier) rather than forming it directly. It will be further appreciated that, alternatively, the step of providing at least one manufacturing intermediate may comprise any sub-steps of forming the manufacturing intermediate such as forming the main body of the at least one manufacturing intermediate from a light-transmitting material and/or applying the a layer of opaque material to two of the three rectangular surfaces of the main body.

The main body of the manufacturing intermediate is of the form of a triangular prism having three rectangular surfaces and two triangular surfaces. It will be appreciated that this means that the shape of the main body of the manufacturing intermediate is defined by two parallel, congruent triangular surfaces one being a copy of the other but translated in a direction perpendicular to the other triangular surface, with one rectangular surface extending between each pair of corresponding sides of the two triangular surfaces.

It will be appreciated that the term axial is intended to refer to a direction that is generally parallel to an axis of the triangular prism. It will be further appreciated that such an axis is perpendicular to each of the triangular surfaces.

The light-transmitting material may comprise any suitable form of glass.

The apertures may be circular.

It will be appreciated that the two apertures, each on a different one of two sides of the each individual triangular prism will, in use, form an inlet and an outlet of the individual triangular prism. The third side will, in use, provide a surface for redirecting light entering the prism through one aperture (the inlet) toward the other aperture (the outlet), for example by total internal reflection.

The triangular cross section of the main body of the manufacturing intermediate may be an isosceles right triangle. That is, the triangle may have two mutually perpendicular shorter sides that are equal in length and one longer side (that is disposed at 45 degrees to each of the shorter sides). The layer of opaque material may be provided on the two shorter sides.

It will be appreciated that dividing the at least one manufacturing intermediate into a plurality of individual triangular prisms may mean separating, cutting, slicing or dicing the at least one manufacturing intermediate into a plurality of individual triangular prisms.

Since the layer of opaque material comprises a plurality of axially spaced apertures it may be referred to as a patterned layer of opaque material.

It will be appreciated that the layer of opaque material may be a continuous layer that extends from one of the rectangular surfaces of the main body to another one of the rectangular surfaces of the main body. Alternatively, the layer of opaque material may be provided in a plurality of separate portions. For example, the layer of opaque material may comprise a first portion that on one of the rectangular surfaces of the main body and a second portion on another one of the rectangular surfaces of the main body.

In some embodiments, a plurality of manufacturing intermediates may be provided and may each be subsequently divided into a plurality of individual triangular prisms.

Advantageously, by providing a plurality of manufacturing intermediates, a two-dimensional array of portions which will eventually each corresponding to an individual triangular prisms can be formed (with accurately controllable positioning, pitch and height of the array). This allows for greater gains in throughput from the use of wafer level optics technology.

Dividing each of the plurality of manufacturing intermediates into a plurality of individual triangular prisms may comprise: arranging the plurality of manufacturing intermediates such that they are mutually parallel and axially aligned to form an array of manufacturing intermediates; and cutting the array of manufacturing intermediates at least once.

Such an array of axially aligned manufacturing intermediates allows for all of the manufacturing intermediates to be divided together in a single cutting operation (or a plurality of such cutting operations).

Arranging the plurality of manufacturing intermediates such that they are mutually parallel and axially aligned to form an array of manufacturing intermediates may involve arranging the plurality of manufacturing intermediates on an adhesive support.

The adhesive support may comprise dicing tape of the type used in lithographic processes.

Cutting the array of manufacturing intermediates at least once may involve using a cutting tool to cut through each manufacturing intermediate in the array of manufacturing intermediates in a direction generally perpendicular to an axial direction.

The cutting tool may be a rotary saw, for example a dicing saw of the type used in lithographic processes.

In some embodiments, before the or each manufacturing intermediate is divided into a plurality of individual triangular prisms, the method may further comprise: supporting the at least one manufacturing intermediate such that one of the rectangular surfaces on which the layer of opaque material provided is accessible; and providing a lens on the main body of the or each manufacturing intermediate at each of the apertures in the layer of opaque material on the surface that is accessible.

Advantageously, by providing the lenses at the apertures before dividing the manufacturing intermediates into individual triangular prisms, the stiffness of the manufacturing intermediates provides additional support, which can reduce, or even prevent, warpage of the light transmitting material.

The plurality of manufacturing intermediates may be supported such that one of the rectangular surfaces on which the layer of opaque material is disposed from each of the manufacturing intermediates lies substantially in a plane.

The lenses may be provided on the main body of the or each manufacturing intermediate at each of the apertures in the layer of opaque material on the surface that is accessible by molding the lenses directly onto the main body.

For example, the lenses may be formed by a wafer level imprinting process. This process may use a PDMS mold. The lenses may be molded from epoxy. The molding may include, or may be followed by, a curing process (for example UV exposure).

Advantageously, the use of the manufacturing intermediates allows for this molding to be performed for an array of the apertures using wafer level optics techniques. This may be referred to as wafer level lens replication onto the manufacturing intermediate(s). The precise control facilitated by the manufacturing intermediate(s) enables concurrent lens structure molding directly on the manufacturing intermediate(s). The adhesion may be achieved by direct crosslinking of polymer onto the (e.g. glass) surface of the light transmitting material.

A further advantage of molding the lenses directly onto the light transmitting material is that it can increase the optical efficiency of the finished product since the material from which the lenses are formed can directly bond to the light transmitting material of the prisms. In contrast, in prior art methods, the lenses are typically formed separately and an additional adhesive layer is used to bond them to the individual prisms.

In some embodiments, before the or each manufacturing intermediate is divided into a plurality of individual triangular prisms one or more surfaces of the manufacturing intermediate may be provided with an anti-reflection coating.

Such an anti-reflection coating may be applied around the manufacturing intermediate(s) and lenses for optical efficiency improvements.

In some embodiments, after the or each manufacturing intermediate is divided into a plurality of individual triangular prisms, the method may further comprise: supporting the individual triangular prisms such that one of the rectangular surfaces that has part of the layer of opaque material with an aperture from each of the individual triangular prisms lies substantially in a plane; and providing a lens on a main body of each individual triangular prism at each of the apertures in the layer of opaque material on the rectangular surfaces that lie in said plane.

Advantageously, by providing the lenses after the division of the manufacturing intermediates into individual triangular prisms, the risk of damage or contamination of the lenses from the division process is avoided. This can allow for higher quality glass lenses to be used without having to subsequently provide any protective coating or the like to lenses.

Although the manufacturing intermediates have already been divided into the individual triangular prisms, because the manufacturing intermediates were provided with a layer of opaque material on two sides and because each individual triangular prism has one of the apertures on each of two sides thereof, the apertures can be used to aid the alignment to the individual triangular prisms to allow for the high throughput batch processing wafer level optics techniques. For example each aperture may be used as an alignment feature (or fiducial) to allow for fast and accurate alignment of the individual triangular prism it is provided on with a corresponding lens.

The lenses may be fabricated separately using a glass injection molding process. The lenses may optionally be coated with anti-reflection coating individually prior to assembly with the individual triangular prisms.

Providing a lens on a main body of each individual triangular prism may comprise: providing a quantity of adhesive at each of the apertures in the layer of opaque material on the rectangular surfaces that lie in said plane; and adhering each lens to a corresponding one of the apertures via said quantities of adhesive.

The adhesive may be an optically clear adhesive and may, for example, comprise an epoxy adhesive. The step of adhering each lens to a corresponding one of the apertures via said quantities of adhesive may comprise any application of pressure and/or elevated temperature. The step of adhering each lens to a corresponding one of the apertures via said quantities of adhesive comprise a curing process, which may involve exposure to radiation (for example ultra violet radiation).

In some embodiments, alignment of each individual triangular prism and a corresponding lens may be achieved using an edge of an aperture in the layer of opaque material as an alignment feature.

The layer of opaque material may be provided on two of the three rectangular surfaces of the main body of each manufacturing intermediate using physical vapor deposition.

The layer of opaque material may comprise chromium. Chromium is a material which can easily be coated onto glass using standard techniques.

In some embodiments, after the or each manufacturing intermediate has been divided into a plurality of individual triangular prisms, a layer of a second opaque material may be provided on one or both triangular surfaces of the individual triangular prisms.

The layers of the second opaque material may be provided by spray coating or screen printing.

The layers of the second opaque material may have a thickness of the order of 2-3 μm.

The second opaque material may have a low optical transmission. For example, the layers of the second opaque material may have a transmission optical density of around 4 OD (i.e. having a transmission of around 0.01%).

According to a second aspect of the present disclosure, there is provided a manufacturing intermediate for use in the method of the first aspect of the present disclosure.

The manufacturing intermediate according to the second aspect of the invention is novel and facilitates many of the advantages of the method according to the according to the first aspect of the invention, as discussed above.

According to a third aspect of the present disclosure, there is provided a manufacturing intermediate comprising: a main body in the form of a triangular prism having three rectangular surfaces and two triangular surfaces, the main body being formed from a light-transmitting material; and a layer of opaque material provided on two of the three rectangular surfaces of the main body, the layer of opaque material comprising a plurality of axially spaced apertures on each of the two of the three rectangular surfaces, each one of the apertures on one of the two surfaces being disposed at substantially the same axial position as one of the apertures on the other one of the two surfaces.

The main body of the manufacturing intermediate is of the form of a triangular prism having three rectangular surfaces and two triangular surfaces. It will be appreciated that this means that the shape of the main body of the manufacturing intermediate is defined by two parallel, congruent triangular surfaces one being a copy of the other but translated in a direction perpendicular to the other triangular surface, with one rectangular surface extending between each pair of corresponding sides of the two triangular surfaces.

It will be appreciated that the term axial is intended to refer to a direction that is generally parallel to an axis of the triangular prism. It will be further appreciated that such an axis is perpendicular to each of the triangular surfaces.

The light-transmitting material may comprise any suitable form of glass.

The apertures may be circular.

It will be appreciated that the two apertures, each on a different one of two sides of the each individual triangular prism will, in use, form an inlet and an outlet of the individual triangular prism. The third side will, in use, provide a surface for redirecting light entering the prism through one aperture (the inlet) toward the other aperture (the outlet), for example by total internal reflection.

The triangular cross section of the main body of the manufacturing intermediate may be an isosceles right triangle. That is, the triangle may have two mutually perpendicular shorter sides that are equal in length and one longer side (that is disposed at 45 degrees to each of the shorter sides). The layer of opaque material may be provided on the two shorter sides.

Since the layer of opaque material comprises a plurality of axially spaced apertures it may be referred to as a patterned layer of opaque material.

It will be appreciated that the layer of opaque material may be a continuous layer that extends from one of the rectangular surfaces of the main body to another one of the rectangular surfaces of the main body. Alternatively, the layer of opaque material may be provided in a plurality of separate portions. For example, the layer of opaque material may comprise a first portion that on one of the rectangular surfaces of the main body and a second portion on another one of the rectangular surfaces of the main body.

The manufacturing intermediate may further comprise a lens on the main body of the manufacturing intermediate at each of the apertures on one of the rectangular surfaces of the main body.

The manufacturing intermediate may further comprise an anti-reflection coating on one or more surfaces of the manufacturing intermediate and/or lenses.

The layer of opaque material may comprise chromium. Chromium is a material which can easily be coated onto glass using standard techniques.

According to a fourth aspect of the present disclosure, there is provided a support for supporting a plurality of manufacturing intermediates according to the third aspect of the present disclosure such that one of the rectangular surfaces on which the layer of opaque material is disposed from each of the manufacturing intermediates lies substantially in a plane.

The support may comprise a support surface that is shaped so as to be complimentary to the manufacturing intermediates. For example, a plurality of features or grooves may be provided in the support surface of the support, each for cooperating with one of the manufacturing intermediates. Each groove may comprise two surfaces that together form a generally triangular groove. The two surfaces may be arranged such they can each contact at least part of one of two surfaces of the manufacturing intermediates.

According to a fifth aspect of the present disclosure, there is provided support for supporting a plurality of individual triangular prisms such that one of the rectangular surfaces from each of the individual triangular prisms lies substantially in a plane.

The support may comprise a support surface that is shaped so as to be complimentary to the plurality of individual triangular prisms. For example, a plurality of recesses may be provided in the support surface of the support, each for cooperating with one of the plurality of individual triangular prisms. Each recess may comprise two surfaces that together form a generally triangular groove. The two surfaces may be arranged such they can each contact at least part of one of two surfaces of an individual triangular prism.

### BRIEF DESCRIPTION OF THE PREFERRED EMBODIMENTS

Some embodiments of the disclosure will now be described by way of example only and with reference to the accompanying drawings, in which:

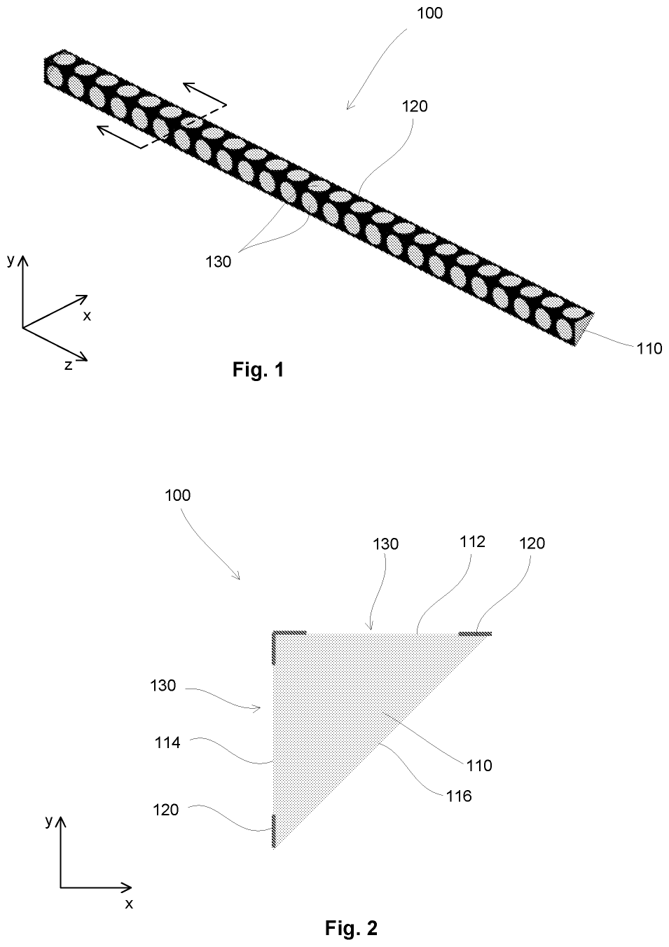

FIG. 1 shows a perspective view of a manufacturing intermediate in accordance with the present disclosure;

FIG. 2 is a cross sectional view of the manufacturing intermediate shown in FIG. 1;

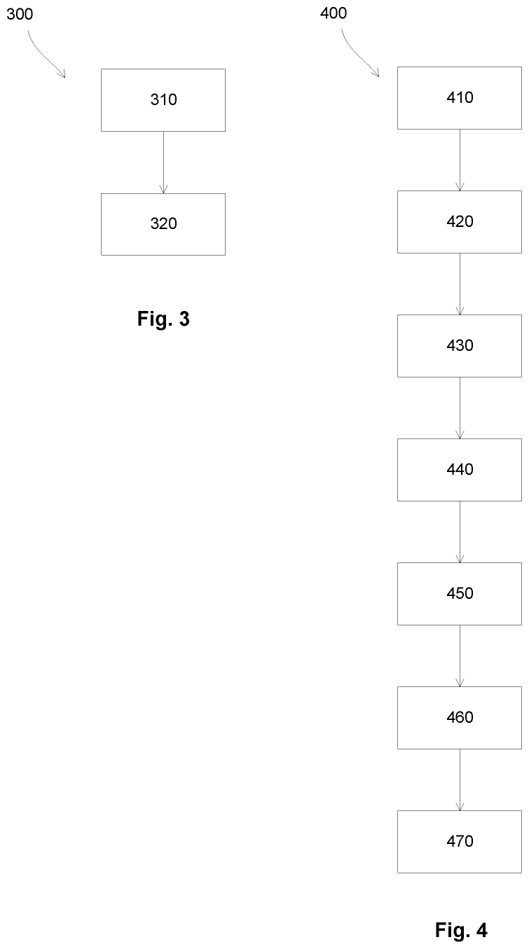

FIG. 3 is a schematic illustration of a first method for producing a plurality of optical prisms in accordance with the present disclosure;

FIG. 4 is a schematic illustration of a second method for producing a plurality of optical prisms in accordance with the present disclosure.

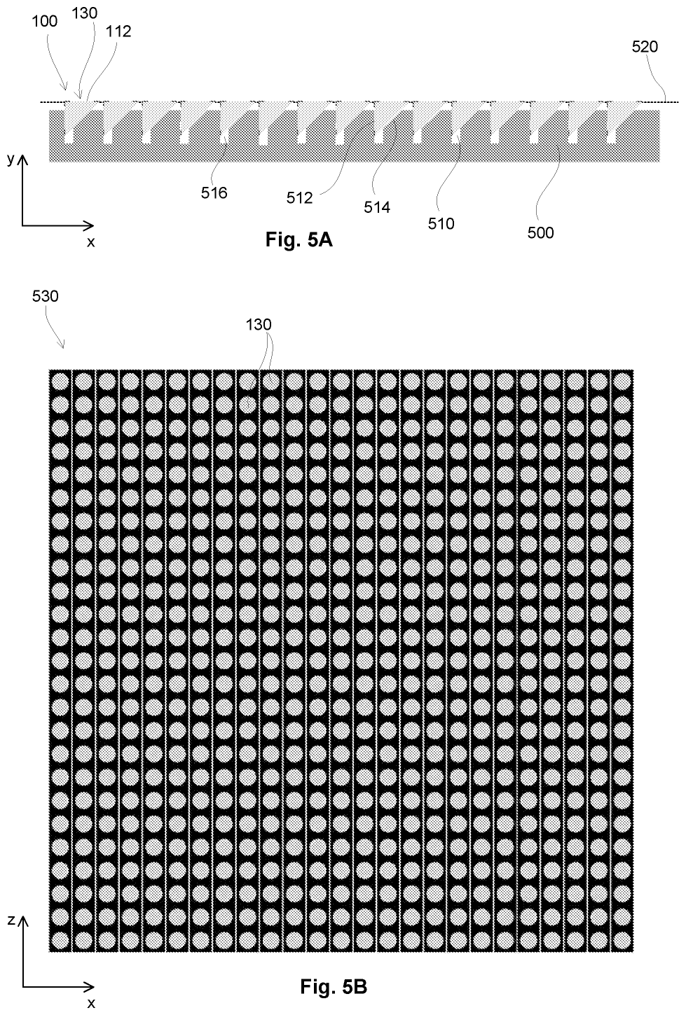

FIG. 5A shows schematically in cross section an array of manufacturing intermediates supported by a support;

FIG. 5B is a plan view of an array of manufacturing intermediates supported by a support;

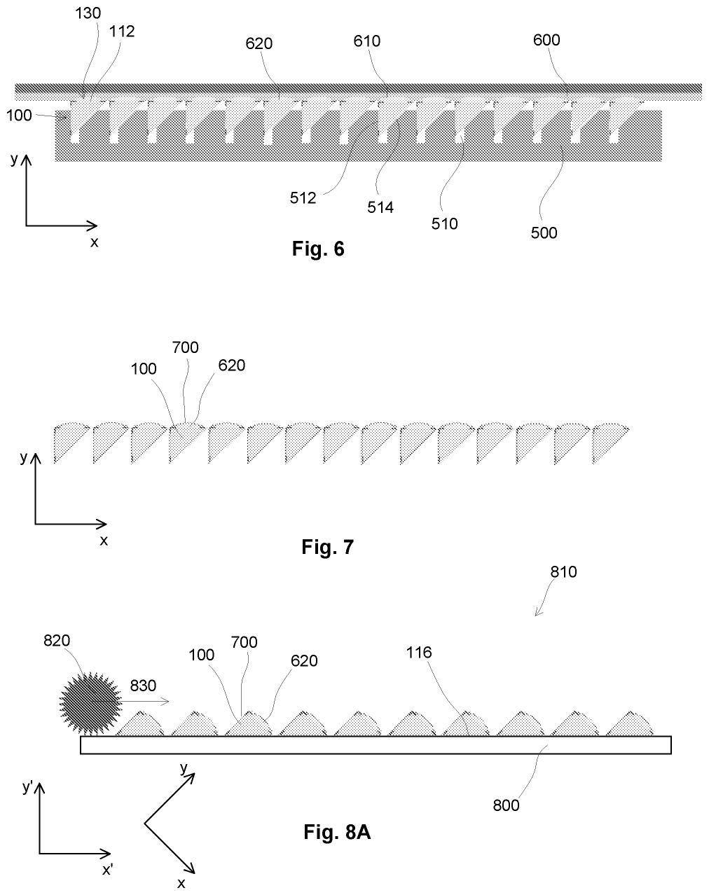

FIG. 6 shows schematically in cross section the array of manufacturing intermediates supported by the support as shown in FIG. 5A and in addition a mold being used to form a plurality of lensed on each manufacturing intermediate;

FIG. 7 is a schematic representation of a plurality of manufacturing intermediates, each with a plurality of lenses, being provided with an anti-reflection coating;

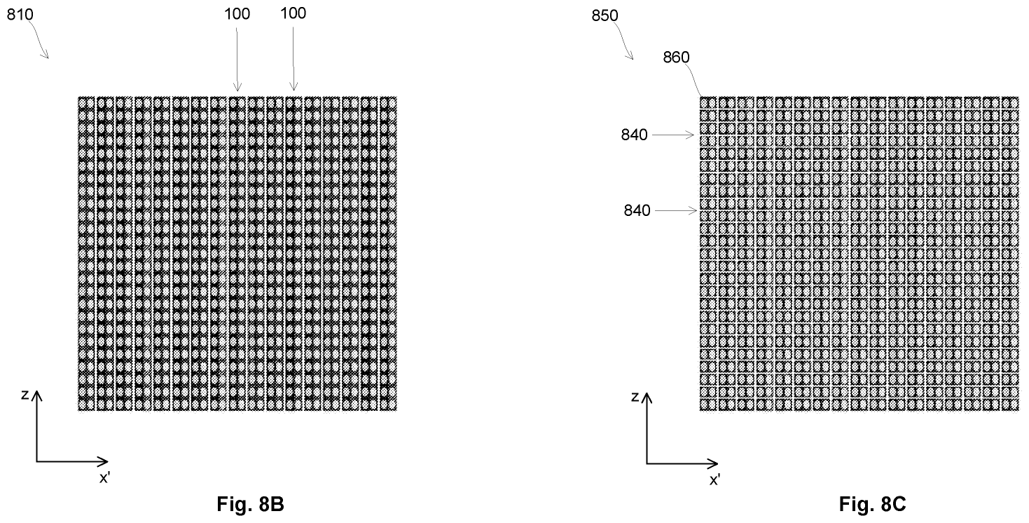

FIG. 8A is a schematic representation of an array of manufacturing intermediates being supported and each being divided into a plurality of individual triangular prisms using a cutting tool;

FIG. 8B shows a plan view of a one-dimensional array of manufacturing intermediates on an adhesive support before being divided by the cutting tool;

FIG. 8C shows a plan view of a two-dimensional array of individual triangular prisms on an adhesive support after being divided by the cutting tool;

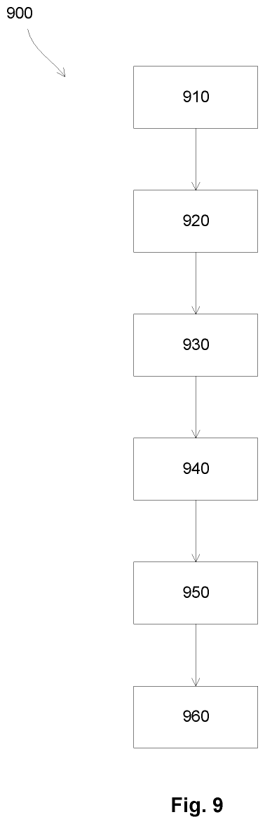

FIG. 9 is a schematic illustration of a third method for producing a plurality of optical prisms in accordance with the present disclosure.

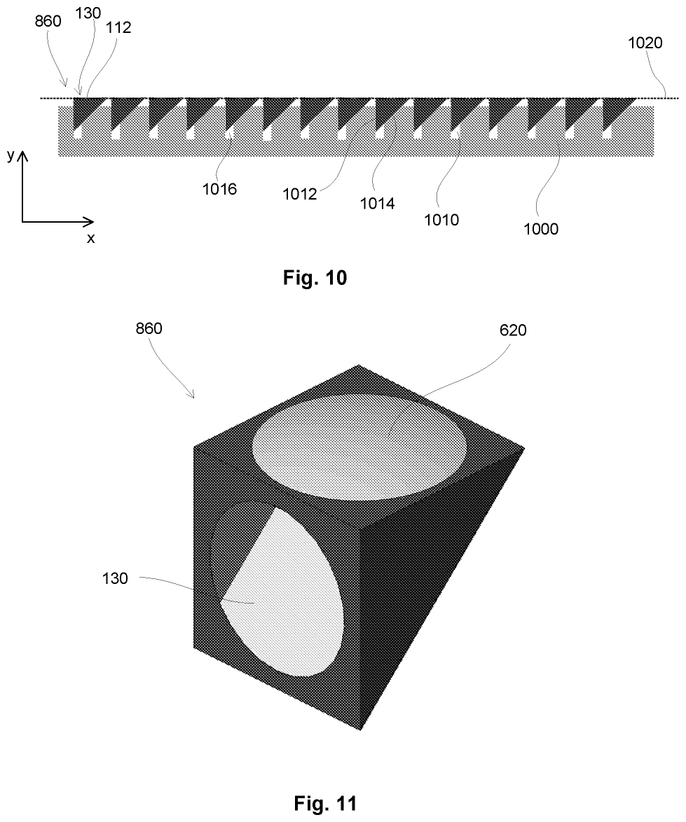

FIG. 10 shows schematically in cross section an array of individual triangular prisms supported by a support; and

FIG. 11 shows an individual triangular prism that may be formed using either of the second or third methods, as shown in FIGS. 4 and 9.

### DETAILED DESCRIPTION OF THE PREFERRED EMBODIMENTS

Generally speaking, the disclosure provides methods for manufacturing a plurality of optical elements, in particular a plurality of prisms. The prisms may, for example, have optical power and may be provided with a lens at one or more surface. In particular, the methods in this disclosure are adapted to use wafer level optics techniques for concurrent manufacture of a plurality of such prisms.

Some examples of such methods are shown in the accompanying figures.

FIGS. 1 and 2 show a manufacturing intermediate 100 in accordance with the present disclosure. FIG. 1 shows a perspective view of the manufacturing intermediate 100 and FIG. 2 shows a cross sectional view of the manufacturing intermediate 100.

The manufacturing intermediate 100 comprises: a main body 110 and a layer of opaque material 120.

The main body 110 is in the form of a triangular prism having three rectangular surfaces 112, 114, 116 (see FIG. 2) and two triangular surfaces. It will be appreciated that this means that the shape of the main body 110 of the manufacturing intermediate 100 is defined by two parallel, congruent triangular surfaces one being a copy of the other but translated in a direction perpendicular to the other triangular surface (the z-direction in FIG. 1), with one rectangular surface extending between each pair of corresponding sides of the two triangular surfaces.

The main body 110 is formed from a light-transmitting material (for example glass). The three rectangular surfaces 112, 114, 116 may be polished.

As used herein the term axial is intended to refer to a direction that is generally parallel to an axis of the triangular prism (the z-direction in FIG. 1). The axis is perpendicular to each of the triangular surfaces of the main body 110.

The triangular cross section of the main body 110 (see FIG. 2) of the manufacturing intermediate 100 is an isosceles right triangle. That is, the triangle has two mutually perpendicular shorter sides 112, 114 that are equal in length and one longer side 116 (that is disposed at 45 degrees to each of the shorter sides 112, 114). The layer of opaque material 120 is provided on the two shorter sides 112, 114.

Unless stated otherwise, throughout the accompanying Figures, direction which is parallel to an axis of a manufacturing intermediate 100 (or an array of parallel manufacturing intermediates 100) will generally be labelled as the z-direction. Similarly, the directions parallel to the two mutually perpendicular shorter sides 112, 114 of the main body are generally labelled as the x and y directions. A direction parallel to the longer side 116 of the main body (that is disposed at 45 degrees to each of the shorter sides 112, 114) is generally labelled as x′ (and a direction perpendicular to x′ and z is generally labelled as y′).

The layer of opaque material 120 is provided on two of the rectangular surfaces 112, 114 of the main body 110. The layer of opaque material 120 comprises a plurality of axially spaced apertures 130 on each of the two rectangular surfaces 112, 114. Each one of the apertures 130 on one of the two surfaces 112 is disposed at substantially the same axial position as one of the apertures 130 on the other one of the two surfaces 114 (see FIG. 1). The apertures 130 are circular although in other embodiments the apertures 130 may have another shape.

Since the layer of opaque material 120 comprises a plurality of axially spaced apertures 130 it may be referred to as a patterned layer of opaque material.

The layer of opaque material 120 may comprise chromium. Chromium is a material which can easily be coated onto glass using standard techniques. For example, the layer of opaque material 120 may be applied using physical vapor deposition (PVD).

It will be appreciated that the layer of opaque material 120 may be applied using various known techniques. The opaque material may be applied selectively such that it is not applied to some portions of the main body 110 (these portions then forming the apertures 130). This may be achieved using, for example, a mask or the like (which may be applied, for example using photolithography). Alternatively, the opaque material may be applied to the whole of each surface 112, 114 and then selectively removed to form the apertures 130.

In this embodiment the layer of opaque material 120 is a continuous layer that extends from one of the rectangular surfaces 112 of the main body 110 to another one of the rectangular surfaces 114 of the main body 110. It will be appreciated that in alternative embodiments, the layer of opaque material may be provided in a plurality of separate portions. For example, the layer of opaque material may comprise a first portion that on one of the rectangular surfaces 112 of the main body and a second portion on another one of the rectangular surfaces 114 of the main body (with a gap or break between the first and second portions).

As discussed further below, in some embodiments the manufacturing intermediate 100 may comprising a lens on the main body 110 of the manufacturing intermediate 110 at each of the apertures 130 on one of the rectangular surfaces 112, 114.

As discussed further below, in some embodiments the manufacturing intermediate 100 may further comprise an anti-reflection coating on one or more surfaces of the manufacturing intermediate 100 and/or lenses.

FIG. 3 is a schematic illustration of a method 300 for producing a plurality of optical prisms in accordance with the present disclosure.

A first step 310 of the method 300 comprises providing at least one manufacturing intermediate. The manufacturing intermediate is of the form of the manufacturing intermediate 100 shown in FIGS. 1 and 2 and described above.

A second step 320 of the method 300 comprises dividing the at least one manufacturing intermediate 100 into a plurality of individual triangular prisms such that each individual triangular prism has one of the apertures 130 on each of two sides thereof.

Advantageously, this method 300 allows for the production of a plurality of prisms at high volume and throughput whilst maintaining high quality and within high manufacturing tolerance, as now discussed.

Prior art methods for manufacturing optical prisms involve the manufacture of each individual prism separately. For example, to ensure sufficient optical quality each individual prism may be formed by injection molding. However, once a main light-transmitting body of the prism has been formed, each such individual prism is typically subject to further processing steps. For example, a lens may be adhered to one surface of the prism to provide the optical component with optical power. In addition, it may be desirable to coat at least some surfaces (with the exception of an inlet portion on one surface and an outlet portion on another surface) with an opaque material, for example to prevent any light from entering or leaving the prism from locations other than the inlet portion and an outlet portion respectively. Disadvantageously, these methods are time consuming and expensive as each individual prism is subject to one or more such subsequent processing steps.

Compared to such known methods, the method 300 shown in FIG. 3 for producing a plurality of optical prisms has the following advantages. First, forming at least one manufacturing intermediate 100 having a layer of opaque material 120 on two sides of the main body 110 and then subsequently dividing this into separate individual prisms is significantly faster and more cost effective than molding a plurality of individual prisms and then providing an opaque layer with an aperture on each of two sides. The main body 110 of the manufacturing intermediate 100 can be formed in a single operation (for example injection molding) and the layer of opaque material 120 can be easily formed using known techniques, for example using physical vapor deposition (PVD).

Second, the at least one manufacturing intermediate 100 having a layer of opaque material 120 on two sides of the main body 110 allows for controlled positioning, pitch and height of an array of portions which will eventually each corresponding to an individual triangular prisms. A single manufacturing intermediate 100 allows for very easy formation of a one-dimensional array of such portions; a plurality of manufacturing intermediates allows for very easy formation of a two-dimensional array of such portions. This is particularly advantageous since it allows a temporal array layout for subsequent processing steps (for example the provision of a lens to each portion and/or the division of these portions via a dicing process) to use wafer level optics technology. This further increases throughput of the manufacture whilst still providing sufficient precision to meets tight dimensional tolerance control.

Third, by providing the layer of opaque material 120 on two sides of the main body 110 of the at least one manufacturing intermediate 100 before any other processing steps, this layer 120 can advantageously aid the alignment of the manufacturing intermediates 100 and/or the individual triangular prisms to allow for high throughput by batch processing using wafer level optics techniques. For example each aperture 130 may be used as an alignment feature (or fiducial) to allow for fast and accurate alignment of the portion it is provided on with some other component (for example using wafer level optics or lithographic techniques).

Therefore the method 300 shown in FIG. 3, through use of the manufacturing intermediates 100, allows high volume manufacturing of prisms (which may be provided with a lens).

The step 310 of providing at least one manufacturing intermediate 100 may comprise sourcing the manufacturing intermediate 100 pre-formed (for example via a third party supplier) rather than forming it directly. Alternatively, the step 310 of providing at least one manufacturing intermediate 100 may comprise any sub-steps of forming the manufacturing intermediate 100 such as, for example, forming the main body 110 of the at least one manufacturing intermediate 100 from a light-transmitting material and/or applying the a layer of opaque material 120 to two of the three rectangular surfaces of the main body 110.

For embodiments wherein the step 310 of providing at least one manufacturing intermediate 100 comprises forming at least part of the manufacturing intermediate 100, the step 310 may comprise providing the layer of opaque material 120 on two of the three rectangular surfaces of the main body 110 of each manufacturing intermediate 100 using physical vapor deposition. The layer of opaque material 120 may comprise chromium, which can easily be coated onto glass using standard techniques.

In use, each of the sides of the each individual triangular prism which have part of the layer of opaque material 120 (and an aperture 130) will, in use, form an inlet and an outlet of the individual triangular prism. The third side will, in use, provide a surface for redirecting light entering the prism through one aperture 130 (the inlet) toward the other aperture 130 (the outlet), for example by total internal reflection.

The step 320 of dividing the at least one manufacturing intermediate 100 into a plurality of individual triangular prisms may mean separating, cutting, slicing or dicing the at least one manufacturing intermediate 100 into a plurality of individual triangular prisms.

In some embodiments, the first step 310 involves providing a plurality of manufacturing intermediates 100 and the second step involves dividing each of the manufacturing intermediates 100 into a plurality of individual triangular prisms.

Advantageously, by providing a plurality of manufacturing intermediates 100, a two-dimensional array of portions which will eventually each corresponding to an individual triangular prisms can be easily formed (with accurately controllable positioning, pitch and height of the array). This allows for greater gains in throughput from the use of wafer level optics technology.

In some embodiments, the second step 320 comprises: arranging a plurality of manufacturing intermediates 100 such that they are mutually parallel and axially aligned to form an array of manufacturing intermediates 100; and cutting the array of manufacturing intermediates 100 at least once. Such an array of axially aligned manufacturing intermediates 100 allows for all of the manufacturing intermediates 100 to be divided together in a single cutting operation (or a plurality of such cutting operations).

In some embodiments, the second step 320 may comprise arranging the manufacturing intermediates 100 on an adhesive support. The adhesive support may comprise dicing tape of the type used in lithographic processes.

In some embodiments, the second step 320 may comprise cutting an array of manufacturing intermediates 100 at least once by using a cutting tool to cut through each manufacturing intermediate 100 in the array of manufacturing intermediates in a direction generally perpendicular an axial direction of the manufacturing intermediates 100. The cutting tool may be a rotary saw, for example a dicing saw of the type used in lithographic processes.

In some embodiments, the method 300 may further comprise an optional step of providing a layer of a second opaque material on one or both triangular surfaces of the individual triangular prisms (after the or each manufacturing intermediate 100 has been divided into the plurality of individual triangular prisms). The layers of the second opaque material may be provided by spray coating or screen printing. The layers of the second opaque material may have a thickness of the order of 2-3 μm. The second opaque material may have a low optical transmission. For example, the layers of the second opaque material may have a transmission optical density of around 4 OD (i.e. having a transmission of around 0.01%).

FIG. 4 is a schematic illustration of a second method 400 for producing a plurality of optical prisms in accordance with the present disclosure. The a second method 400 for producing a plurality of optical prisms in accordance with the present disclosure is a specific example of the first method 300 for producing a plurality of optical prisms as shown in FIG. 3.

A first step 410 of the second method 400 (which is equivalent to the first step 310 of the first method 300) comprises providing a plurality of manufacturing intermediates 100 of the form shown in FIGS. 1 and 2 and described above.

A second 420 of the second method 400 comprises supporting the plurality of manufacturing intermediates 100 such that one of the rectangular surfaces 112 on which the layer of opaque material 120 provided is accessible. In particular, the plurality of manufacturing intermediates 100 are supported such that one of the rectangular surfaces 112 on which the layer of opaque material 120 is disposed from each of the manufacturing intermediates 100 lies substantially in a plane.

An example of how this may be achieved is explained with reference to FIG. 5A. A support 500 is provided which has support surface (which in use may be an upper surface of the support) that is shaped support the manufacturing intermediates 100. In particular, a plurality of features or grooves 510 is provided in the support surface of the support 500 each for cooperating with one of the manufacturing intermediates 100. Each groove 510 comprises two surfaces 512, 514 that together form a generally triangular groove 510. The two surfaces 512, 514 are arranged such they can each contact at least part of one of two surfaces 114, 116 of the manufacturing intermediates 100 respectively. The grooves 510 are arranged such that when a manufacturing intermediate 100 is disposed in each one a surface 112 from each of the manufacturing intermediates lies substantially in a plane 520. The support 500 may be referred to as a chuck or a stage.

The manufacturing intermediates 100 may be clamped to the support 500. For example, the manufacturing intermediates 100 may be mechanically clamped or vacuum clamped (also referred to as suction clamping) to the support 500. It will be appreciated that other types of clamping may alternatively be used. In order to facilitate vacuum clamping, in addition to a generally triangular portion of the groove 510 defined by the two surfaces 512, 514 that contact surfaces 114, 116 of the manufacturing intermediates 100, the groove 510 may further comprise a channel 516 that is not occupied by the manufacturing intermediates 100 when supported by the support 500. In use, once the manufacturing intermediates 100 are in contact with the support 500, these channels 516 may be maintained at lower pressure than ambient pressure to create a suction force that clamps the manufacturing intermediates to the support 500.

In this way, as can be seen in FIG. 5B, a two dimensional array 530 of apertures 130 can be easily and accurately formed. It will be appreciated that each of the apertures 130 shown in FIG. 5B corresponds to a portion of a manufacturing intermediate 100 that will form a different individual triangular prism. Therefore, the array 530 shown in FIG. 5B may alternatively be described as a two-dimensional array of portions of manufacturing intermediates 100 that correspond to different individual triangular prisms.

Referring again to FIG. 4, a third step 430 of the second method 400 comprises providing a lens on the main body 110 of each manufacturing intermediate 100 at each of the apertures 130 in the layer of opaque material 120 on the surface 112 that is accessible. That is, providing a lens at each of the apertures 130 in two-dimensional array 530 of apertures shown in FIG. 5B. By providing the lenses at the apertures 130 before dividing the manufacturing intermediates 100 into individual triangular prisms, the stiffness of the manufacturing intermediates 100 provides additional support.

Advantageously, this additional support can reduce, or even prevent, warpage of the light transmitting material (of either the main body 110 and/or the lenses).

In particular, step 430 of the second method 400 may comprise forming the lenses on the main bodies 110 at each aperture 130. For example, the lenses may be provided on the main bodies 110 at each apertures 130 by molding the lenses directly onto the main bodies 110 of the manufacturing intermediates 100.

An example of how this may be achieved is explained with reference to FIG. 6. A mold 600 comprising a two dimensional array of individual mold portions 610 is provided.

Each individual mold portion comprises a generally concave recess on the mold 600. The configuration of the two dimensional array of individual mold portions 610 substantially matches the two dimensional array 530 apertures 130 formed in the plane 520 (see FIG. 5B). The mold is aligned with the two dimensional array 530 apertures 130 formed in the plane 520 such that each individual mold portion 610 lies at substantially the same position in a plane parallel to the plane 520 as one of the apertures 130 in the two dimensional array 530 apertures 130 formed in the plane 520 (i.e. the x-z plane in the Figures). The mold 600 is then brought into contact with the plurality of manufacturing intermediates 100. For example, a portion of the mold 600 surrounding each individual mold portion 610 may contact a portion of the layer of opaque material 120 surrounding a corresponding aperture 130.

A lens 620 may be formed on each main body 110 at each aperture 130 by molding using the individual mold portions 610. For example, the lenses 620 may be formed from epoxy by a wafer level imprinting process. The mold 600 may be a PDMS mold. That is, the mold 600 may be formed from PDMS (Polydimethylsiloxane). The molding process may comprise, or may be followed by, a curing process (for example UV exposure).

Advantageously, the use of the manufacturing intermediates 100 allows for this molding to be performed for an array of the apertures 130 using wafer level optics techniques. This may be referred to as wafer level lens replication onto the manufacturing intermediates 100. The precise control facilitated by the manufacturing intermediates 100 enables concurrent lens structure molding directly on the manufacturing intermediates 100. The adhesion may be achieved by direct crosslinking of polymer onto the surface 112 of the light transmitting material of the main body (for example glass).

A further advantage of molding the lenses 620 directly onto the light transmitting material of the main body 110 is that it can increase the optical efficiency of the finished product since the material from which the lenses 620 are formed can directly bond to the light transmitting material of the prisms. In contrast, in prior art methods, the lenses are typically formed separately and an additional adhesive layer is used to bond them to the individual prisms.

Referring again to FIG. 4, a fourth step 440 of the second method 400 comprises providing one or more surfaces of the manufacturing intermediate 100 with an anti-reflection coating. This is illustrated schematically in FIG. 7. In particular, an anti-reflection coating 700 is applied all round each manufacturing intermediate 100 (and the plurality of lenses 620 that have been provided thereon at step 430). Substantially all of the surfaces may be covered (although it will be appreciated that the two triangular surfaces of the main body 110 may be omitted from this coating process). Such an anti-reflection coating applied around the manufacturing intermediates 100 and lenses 620 may provide optical efficiency improvements.

It will be appreciated that the manufacturing intermediates are removed from the support 500 before the anti-reflection coating 700 is applied.

Referring again to FIG. 4, a fifth step 450 of the second method 400 comprises: arranging the plurality of manufacturing intermediates 100 such that they are mutually parallel and axially aligned to form an array of manufacturing intermediates 100. As used here, axially aligned means that the manufacturing intermediates 100 are disposed at substantially the same position in a direction parallel to their (parallel) axes (the z-direction in FIGS. 8A-8C). Such an array of axially aligned manufacturing intermediates 100 allows for all of the manufacturing intermediates 100 to be divided together in a single cutting operation (or a plurality of such cutting operations).

A sixth step 460 of the second method 400 comprises cutting the array of manufacturing intermediates 100 at least once by using a cutting tool to cut through each manufacturing intermediate 100 in the array of manufacturing intermediates in a direction generally perpendicular to an axial direction of the manufacturing intermediates 100.

It will be appreciated that the fifth and sixth steps 450, 460 of the second method 400 are equivalent to the second step 320 of the first method 300.

The fifth and sixth steps 450, 460 of the second method 400 are now described in more detail with reference to FIGS. 8A to 8C.

The fifth step 450 comprises arranging the manufacturing intermediates 100 on an adhesive support 800 (see FIG. 8A) such that they are mutually parallel and axially aligned to form an array 810 of manufacturing intermediates 100. The adhesive support 800 may comprise dicing tape of the type used in lithographic processes. In particular, the manufacturing intermediates 100 are arranged such that the rectangular surface 116 of each main body 110 that corresponds to the longer side of the triangular cross section of the main body 110 is in contact with the adhesive support.

FIG. 8B shows a plan view of the (one-dimensional) array 810 of manufacturing intermediates on the adhesive support 800.

Also shown in FIG. 8A is a cutting tool 820. The cutting tool may be a rotary saw, for example a dicing saw of the type used in lithographic processes.

During the sixth step 460 of the second method 400, the cutting tool may be used to make a plurality of cuts through each manufacturing intermediate 100 in the array 810 of manufacturing intermediates 100 in a direction 830 generally perpendicular to the axial direction of the manufacturing intermediates 100. In particular, a cut is made between adjacent pairs of apertures 130. As a result of each cut through each manufacturing intermediate 100 in the array 810 of manufacturing intermediates 100 made by the cutting tool 820 a gap 840 (see FIG. 8C) is formed in the array 810 of manufacturing intermediates 100 (in the x′ direction). After all of the cuts through each manufacturing intermediate 100 in the array 810 of manufacturing intermediates 100 a (two-dimensional) array 850 of individual triangular prisms 860 is formed. FIG. 8C shows a plan view of the two-dimensional array 850 of individual triangular prisms 860 on the adhesive support 800.

Referring again to FIG. 4, a seventh step 470 of the second method 400 comprises providing a layer of a second opaque material on both triangular surfaces of the individual triangular prisms 860. The layers of the second opaque material may be provided by any convenient method such as, for example, spray coating or screen printing. The layers of the second opaque material may have a thickness of the order of 2-3 μm. The second opaque material may be black. The second opaque material may have a low optical transmission. For example, the layers of the second opaque material may have a transmission optical density of around 4 OD (i.e. having a transmission of around 0.01%).

FIG. 9 is a schematic illustration of a third method 900 for producing a plurality of optical prisms in accordance with the present disclosure. The a third method 900 for producing a plurality of optical prisms in accordance with the present disclosure is an alternative specific example of the first method 300 for producing a plurality of optical prisms as shown in FIG. 3.

A first step 910 of the third method 900 comprises providing a plurality of manufacturing intermediates 100 of the form shown in FIGS. 1 and 2 and described above. The first step 910 of the third method 900 is equivalent to the first step 410 of the second method 400 (and the first step 310 of the first method 300) and therefore will not be discussed further here.

A second step 920 of the third method 900 comprises arranging the plurality of manufacturing intermediates 100 such that they are mutually parallel and axially aligned to form an array of manufacturing intermediates 100. The second step 920 of the third method 900 is equivalent to the fifth step 450 of the second method 400 and therefore will not be discussed further here.

A third step 930 of the third method 900 comprises cutting the array of manufacturing intermediates 100 at least once by using a cutting tool to cut through each manufacturing intermediate 100 in the array of manufacturing intermediates in a direction generally perpendicular to an axial direction of the manufacturing intermediates 100. The third step 930 of the third method 900 is equivalent to the sixth step 460 of the second method 400 and therefore will not be discussed further here.

A fourth step 940 of the third method 900 comprises providing a layer of a second opaque material on both triangular surfaces of the individual triangular prisms 860. The fourth step 940 of the third method 900 is equivalent to the seventh step 470 of the second method 400 and therefore will not be discussed further here.

A fifth step 950 of the third method 900 comprises: supporting the individual triangular prisms 860 such that one of the rectangular surfaces that has part of the layer of opaque material 120 with an aperture 130 from each of the individual triangular prisms 860 lies substantially in a plane. The firth step 950 of the third method 900 is generally equivalent to the second step 420 of the second method 400 although it is performed after the manufacturing intermediates 100 have been divided into a plurality of individual triangular prisms 860. It may be achieved in a similar way to the method described above with reference to FIG. 5A, as now described with reference to FIG. 10.

A support 1000 is provided which has support surface (which in use may be an upper surface of the support 1000) that is shaped support the individual triangular prisms 860. In particular, a plurality of features or recesses 1010 is provided in the support surface of the support 1000 each for cooperating with one of the individual triangular prisms 860. Each recess 1010 comprises two surfaces 1012, 1014 that together form a recess 1010 that is generally triangular in cross section. Optionally, in addition two additional surfaces may be provided to provide ease of alignment of the individual triangular prisms 860 in the z-direction. The two surfaces 1012, 1014 are arranged such they can each contact at least part of one of two surfaces of the individual triangular prisms 860 (that correspond to two surfaces 114, 116 of the manufacturing intermediates 100 respectively). The recesses 1010 are arranged such that when an individual triangular prism is disposed in each one a surface from each of the individual triangular prisms 860 lies substantially in a plane 1020. The support 1000 may be referred to as a chuck or a stage.

The individual triangular prisms 860 may be clamped to the support 1000. For example, the individual triangular prisms 860 may be vacuum or suction clamped to the support 1000. It will be appreciated that other types of clamping may alternatively be used. In order to facilitate vacuum clamping, in addition to a generally triangular portion of the recess 1010 defined by the two surfaces 1012, 1014 that contact surfaces of the individual triangular prisms 860, the recess 1010 may further comprise a channel 1016 that is not occupied by the individual triangular prisms 860 when supported by the support 1000. In use, once the individual triangular prisms 860 are in contact with the support 1000, these channels 1016 may be maintained at lower pressure than ambient pressure to create a suction force that clamps the individual triangular prisms 860 to the support 1000.

In this way, as can be seen in FIG. 5B, a two dimensional array 530 of apertures 130 can be easily and accurately formed. It will be appreciated that each of the apertures 130 shown in FIG. 5B corresponds to a portion of a manufacturing intermediate 100 that will form a different individual triangular prism. Therefore, the array 530 shown in FIG. 5B may alternatively be described as a two-dimensional array of portions of manufacturing intermediates 100 that correspond to different individual triangular prisms.

A sixth step 960 of the third method 900 comprises: providing a lens on a main body of each individual triangular prism at each of the apertures 130 in the layer of opaque material 120 on the rectangular surfaces that lie in the plane 1020. The sixth step 960 of the third method 900 is generally equivalent to the third step 430 of the second method 400 although the provision of lenses is achieved in a different way.

Advantageously, by providing the lenses after the division of the manufacturing intermediates 100 into individual triangular prisms 860, the risk of damage or contamination of the lenses from the division process is avoided. This can allow for higher quality glass lenses to be used without having to subsequently provide any protective coating or the like to lenses.

Although the manufacturing intermediates 100 have already been divided into the individual triangular prisms 860, because the manufacturing intermediates 100 were provided with a layer of opaque material 120 on two sides 112, 114 and because each individual triangular prism has one of the apertures 130 on each of two sides thereof, the apertures 130 can be used to aid the alignment to the individual triangular prisms to allow for the high throughput batch processing wafer level optics techniques. For example each aperture 130 may be used as an alignment feature (or fiducial) to allow for fast and accurate alignment of the individual triangular prism 860 it is provided on with a corresponding lens.

The lenses may be fabricated separately through a glass injection molding process. The lenses may optionally be coated with anti-reflection coating individually prior to assembly with the individual triangular prisms.

The step 960 of providing a lens on a main body of each individual triangular prism 860 may comprise: providing a quantity of adhesive at each of the apertures 130 in the layer of opaque material 120 on the rectangular surfaces that lie in the plane 1020; and adhering each lens to a corresponding one of the apertures via said quantities of adhesive.

The adhesive may be an optically clear adhesive and may, for example, comprise an epoxy adhesive. The step of adhering each lens to a corresponding one of the apertures via said quantities of adhesive may comprise any application of pressure and/or elevated temperature. The step of adhering each lens to a corresponding one of the apertures via said quantities of adhesive comprise a curing process, which may involve exposure to radiation (for example ultra violet radiation).

Alignment of each individual triangular prism 860 and a corresponding lens may be achieved using an edge of an aperture in the layer of opaque material as an alignment feature.

FIG. 11 shows an individual triangular prism 860 that may be formed using either of the second or third methods 400, 900.

Embodiments of the present disclosure can be employed in many different applications including any optical system or imaging system, for example, in the cellular telephone (mobile telephone) and other industries.

### LIST OF REFERENCE NUMERALS

100 manufacturing intermediate
110 a main body
120 a layer of opaque material
112, 114 two mutually perpendicular shorter sides of the main body
116 a longer side of the main body
130 a plurality of axially spaced apertures in the layer of opaque material
300 a first method for producing a plurality of optical prisms
310 a first step of the first method 300
320 a second step of the first method 300
400 a second method for producing a plurality of optical prisms
410 a first step of the second method 400
420 a second step of the second method 400
430 a third step of the second method 400
440 a fourth step of the second method 400
450 a fifth step of the second method 400
460 a sixth step of the second method 400
470 a seventh step of the second method 400
500 a support
510 a plurality of grooves
512, 514 two surfaces of each of the grooves
516 a channel
520 a plane
530 two dimensional array of apertures
600 a mold
610 individual mold portions
620 a lens
700 an anti-reflection coating
800 an adhesive support
810 an array of manufacturing intermediates
820 a cutting tool
830 a cutting direction
840 a gap
850 a two-dimensional array of individual triangular prisms
860 an individual triangular prism
900 a third method for producing a plurality of optical prisms
910 a first step of the third method 900
920 a second step of the third method 900
930 a third step of the third method 900
940 a fourth step of the third method 900
950 a fifth step of the third method 900
960 a sixth step of the third method 900
1000 a support
1010 a plurality of recesses
1012, 1014 two surfaces of each of the recesses
1016 a channel
1020 a plane

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in any embodiments, whether alone or in any appropriate combination with any other feature disclosed or illustrated herein.

1. A method for producing a plurality of optical prisms, the method comprising:
providing at least one manufacturing intermediate, the manufacturing intermediate comprising: a main body in the form of a triangular prism having three rectangular surfaces and two triangular surfaces, the main body being formed from a light-transmitting material; and a layer of opaque material provided on two of the three rectangular surfaces of the main body, the layer of opaque material comprising a plurality of axially spaced apertures on each of the two of the three rectangular surfaces, each one of the apertures on one of the two surfaces being disposed at substantially the same axial position as one of the apertures on the other one of the two surfaces; and
dividing the at least one manufacturing intermediate into a plurality of individual triangular prisms such that each individual triangular prism has one of the apertures on each of two sides thereof.

2. The method of claim 1, wherein a plurality of manufacturing intermediates are provided and are each subsequently divided into a plurality of individual triangular prisms.

3. The method of claim 2 wherein dividing each of the plurality of manufacturing intermediates into a plurality of individual triangular prisms comprises:
arranging the plurality of manufacturing intermediates such that they are mutually parallel and axially aligned to form an array of manufacturing intermediates; and
cutting the array of manufacturing intermediates at least once.

4. The method of claim 3 wherein:
(a) arranging the plurality of manufacturing intermediates such that they are mutually parallel and axially aligned to form an array of manufacturing intermediates involves arranging the plurality of manufacturing intermediates on an adhesive support; or
(b) cutting the array of manufacturing intermediates at least once involves using a cutting tool to cut through each manufacturing intermediate in the array of manufacturing intermediates in a direction generally perpendicular to an axial direction.

5. (canceled)

6. The method of claim 1 wherein before the or each manufacturing intermediate is divided into a plurality of individual triangular prisms, the method further comprises:
supporting the at least one manufacturing intermediate such that one of the rectangular surfaces on which the layer of opaque material provided is accessible; and
providing a lens on the main body of the or each manufacturing intermediate at each of the apertures in the layer of opaque material on the surface that is accessible.

7. The method of claim 6 wherein:
(a) a plurality of manufacturing intermediates are provided and are each subsequently divided into a plurality of individual triangular prisms and wherein the plurality of manufacturing intermediates are supported such that one of the rectangular surfaces on which the layer of opaque material is disposed from each of the manufacturing intermediates lies substantially in a plane; or
(b) the lenses are provided on the main body of the or each manufacturing intermediate at each of the apertures in the layer of opaque material on the surface that is accessible by molding the lenses directly onto the main body; or
(c) before the or each manufacturing intermediate is divided into a plurality of individual triangular prisms one or more surfaces of the manufacturing intermediate are provided with an anti-reflection coating.

8.-9. (canceled)

10. The method of claim 1 wherein after the or each manufacturing intermediate is divided into a plurality of individual triangular prisms, the method further comprises:
supporting the individual triangular prisms such that one of the rectangular surfaces that has part of the layer of opaque material with an aperture from each of the individual triangular prisms lies substantially in a plane; and
providing a lens on a main body of each individual triangular prism at each of the apertures in the layer of opaque material on the rectangular surfaces that lie in said plane.

11. The method of claim 10 wherein providing a lens on a main body of each individual triangular prism comprises:
providing a quantity of adhesive at each of the apertures in the layer of opaque material on the rectangular surfaces that lie in said plane;
and adhering each lens to a corresponding one of the apertures via said quantities of adhesive.

12. The method of claim 10 wherein alignment of each individual triangular prism and a corresponding lens is achieved using an edge of an aperture in the layer of opaque material as an alignment feature.

13. The method of claim 1 wherein the layer of opaque material is provided on two of the three rectangular surfaces of the main body of each manufacturing intermediate using physical vapor deposition.

14. The method of claim 1 wherein the layer of opaque material comprises chromium.

15. The method of claim 1 wherein after the or each manufacturing intermediate has been divided into a plurality of individual triangular prisms, a layer of a second opaque material is provided on one or both triangular surfaces of the individual triangular prisms.

16. The method of claim 15 wherein the layers of the second opaque material are provided by spray coating or screen printing.

17. A manufacturing intermediate for use in the method of claim 1.

18. A manufacturing intermediate comprising:
a main body in the form of a triangular prism having three rectangular surfaces and two triangular surfaces, the main body being formed from a light-transmitting material; and
a layer of opaque material provided on two of the three rectangular surfaces of the main body, the layer of opaque material comprising a plurality of axially spaced apertures on each of the two of the three rectangular surfaces, each one of the apertures on one of the two surfaces being disposed at substantially the same axial position as one of the apertures on the other one of the two surfaces.

19. The manufacturing intermediate of claim 18 further comprising a lens on the main body of the manufacturing intermediate at each of the apertures on one of the rectangular surfaces of the main body.

20. The manufacturing intermediate of claim 19 further comprising an anti-reflection coating on one or more surfaces of the manufacturing intermediate and/or lenses.

21. The manufacturing intermediate of claim 18 wherein the layer of opaque material comprises chromium.

22. A support for supporting a plurality of manufacturing intermediates according to claim 18 such that one of the rectangular surfaces on which the layer of opaque material is disposed from each of the manufacturing intermediates lies substantially in a plane.

23. A support for supporting a plurality of individual triangular prisms such that a rectangular surface from each of the individual triangular prisms lies substantially in a plane.
